(19) United States
(12) Patent Application Publication
(10) Pub. No.: US 2015/0204751 A1
(43) Pub. Date: Jul. 23, 2015

(54) METHODS AND APPARATUS FOR AIRCRAFT STRAIN SENSOR CALIBRATION

(71) Applicant: ATA Engineering, Inc., San Diego, CA (US)

(72) Inventors: Robert Curtis Rands, San Diego, CA (US); Joshua Tolford Davis, San Diego, CA (US); Kevin Louis Napolitano, San Diego, CA (US)

(21) Appl. No.: 13/855,598

(22) Filed: Apr. 2, 2013

Related U.S. Application Data
(60) Provisional application No. 61/655,798, filed on Jun. 5, 2012.

(51) Int. Cl. G01L 25/00; G01N 19/00; B64F 5/00

(52) U.S. Cl. CPC G01L 25/00; B64F 5/0045; G01N 19/00

(57) ABSTRACT

A method of calibrating a plurality of structural health sensors incorporated into an aircraft is provided, wherein the plurality of structural health sensors coupled to a pre-existing interconnect fixture within the aircraft. The method includes: establishing a connection with the plurality of predetermined structural health sensors via the pre-existing interconnect fixture; and providing a plurality of adapters, each configured to mechanically interface with a respective mechanical coupling point. For each of the mechanical coupling points, an actuation system is coupled to the mechanical coupling point via an associated adapter and a force is applied to the mechanical coupling point while acquiring a force signal indicative of the force applied to the mechanical coupling point and at least one structural health signal indicative of the output of one or more of the plurality of structural health sensors.

### CROSS-REFERENCE TO RELATED APPLICATIONS

This application claims priority to U.S. Prov. Pat. App. No. 61/655,798, filed Jun. 5, 2012, the contents of which are hereby incorporated by reference.

### STATEMENT REGARDING FEDERALLY SPONSORED RESEARCH OR DEVELOPMENT

This invention was made with U.S. Government support under contract number N68335-10-C-0187, awarded by the U.S. Navy. The U.S. Government has certain rights in the invention.

### FIELD OF THE INVENTION

This invention generally relates to strain sensor devices, and more specifically relates to methods for calibrating strain sensor devices incorporated into aircraft.

### BACKGROUND OF THE INVENTION

Structural health monitoring programs for modern aircraft typically use permanently installed structural health sensors (e.g., “strain sensors”) to compute in-flight loads on individual fleet aircraft. The load histories are used by structural fatigue life tracking methods to predict remaining structural life for individual aircraft. It has been seen that strain sensor readings for a given load can vary significantly from aircraft to aircraft due to manufacturing and installation variations. For example, strain reading errors of 10% can lead to errors of more than 50% in predicted fatigue life, thereby posing a serious obstacle to ensuring safety and minimizing maintenance costs. Hence, it is advantageous to resolve discrepancies in strain sensor readings in fatigue life tracking programs.

Known methods for calibrating aircraft strain sensors are undesirable in a number of respects. Specifically, they are typically costly, inaccurate, and provide poor repeatability, leading to substantial errors in the prediction of remaining life. One conventional approach requires that each aircraft be placed in a full-scale test rig. This approach is expensive and time-consuming for most aircraft fleets. An alternate method, using in-flight calibration, compares the strain sensor output to the loads assumed during tightly prescribed flight maneuvers. This method is considerably less accurate because maneuvers that can repeat loads on certain portions of the airframe, such as the vertical tail or canopy sill, are difficult to prescribe.

Accordingly, there is a need for improved systems and methods for calibrating structural health sensors incorporated into aircraft.

### BRIEF DESCRIPTION OF DRAWINGS

The present invention will hereinafter be described in conjunction with the appended drawings, where like designations denote like elements, and:

FIG. 1 is a conceptual overview of an aircraft depicting exemplary mechanical coupling points (triangular regions) and exemplary structural health sensor locations (circular regions);

FIG. 2 is a conceptual system overview in accordance with one embodiment of the present invention;

FIG. 3 is a flowchart depicting an exemplary method in accordance with the present invention;

FIG. 4 depicts an exemplary integrated, portable device in accordance with various embodiments of the invention;

FIGS. 5A and 5B together depict a sensor interface connected to a pre-existing signal interconnect fixture in accordance with one embodiment of the invention;

FIGS. 6A-6D depict various adapters in accordance with the present invention;

FIG. 7 illustrates an outer wing tip adapter in accordance with one embodiment of the present invention;

FIG. 8 illustrates an inner wing jack point adapter in accordance with one embodiment of the present invention; and

FIG. 9 illustrates a horizontal tail spindle load adapter in accordance with one embodiment of the present invention.

### DETAILED DESCRIPTION OF THE INVENTION

The following detailed description presents a number of example embodiments and is not intended to limit the invention or the application and uses of the invention. Furthermore, there is no intention to be bound by any expressed or implied theory presented in the preceding technical field, background, brief summary, or the following detailed description.

In general, the present invention relates to low-cost systems and methods for quickly calibrating a plurality of structural health sensors (or simply “sensors”) incorporated into an aircraft. As will be shown, what is provided is a flexible, automated calibration system that is portable, low-cost, can be used by personnel with relatively little training, and can be owned and operated on the fleet level.

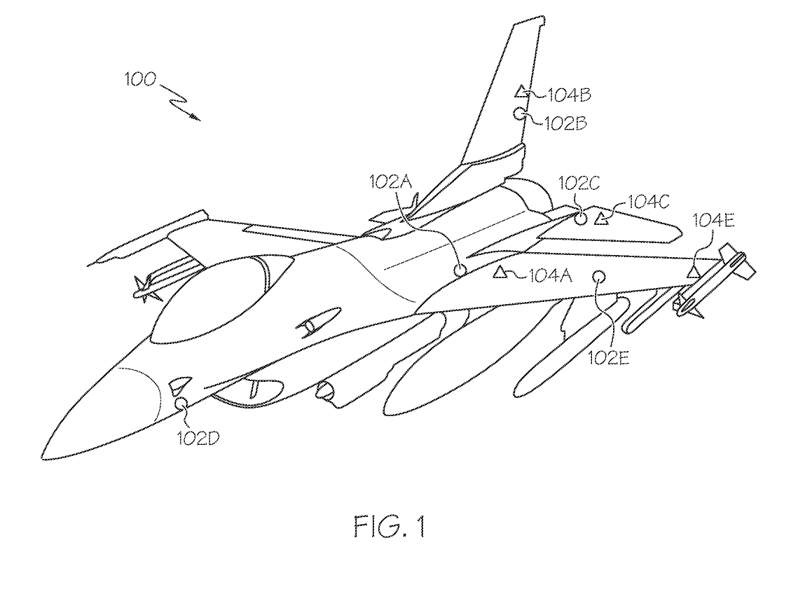

FIG. 1 is a conceptual overview of an aircraft 100 depicting example integrated structural health sensor locations 102 (i.e., 102A-E) useful in describing the present invention. For simplicity, reference numerals 102 may also be used herein to refer to the sensors themselves (i.e., the individual structural health sensors at those locations). As mentioned above, structural health sensors are used in connection with structural health monitoring programs to compute in-flight loads on individual fleet aircraft. The load histories are used by structural fatigue life tracking methods to predict remaining structural life for the aircraft. In this regard, structural health sensors 102 may be strain sensors, load cells, stress sensors, load bridges, or any other sensor configured to sense some attribute of structural health. It will be understood that the sensor locations depicted in FIG. 1 are not intended to be limiting, but are merely provided for the purpose of example, and that in practice the location and number of such sensors will vary greatly. In the illustrated embodiment, structural health sensors 102 are incorporated into the wing root and fold (102A and 102E), on the vertical and horizontal tails (102B and 102C), on the forward section of the fuselage (102D), as well as a variety of other locations. The plurality of structural health sensors will typically be coupled to a pre-existing (and accessible) interconnect fixture (e.g., a cable, bus, or the like) within aircraft 100. Also depicted in FIG. 1 are a number of mechanical coupling points 104 (104A-E), as will be discussed in further detail below.

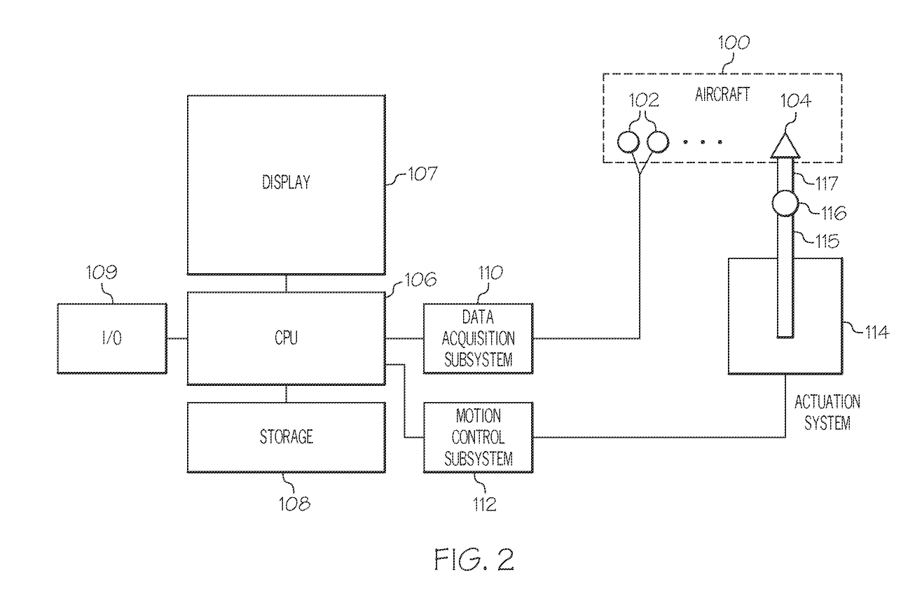

FIG. 2 is a conceptual block diagram of a calibration system 200 in accordance with one embodiment of the present invention. As shown, calibration system 200 generally includes an actuation system 114 configured to engage a mechanical coupling point 104 of aircraft 100 via an adapter 117. Actuation system 114 also includes an actuator 115 (e.g., a linear actuator) having a force sensor 116 integrated therein. Force sensor 116 is suitably configured such that it is capable of sensing the force (tensile and/or compressive) applied by actuation system 114 to mechanical coupling point 104. CPU 106 (or other suitable microcontroller or processor) is communicatively coupled to a data acquisition subsystem 110, a motion control subsystem 112, I/O components 109 (e.g., keyboard, mouse, etc.), and a display 107. One or more of components 106, 107, 108, and 109 may be integrated into a desktop computer, laptop computer, tablet computer, or any other such computing device known in the art.

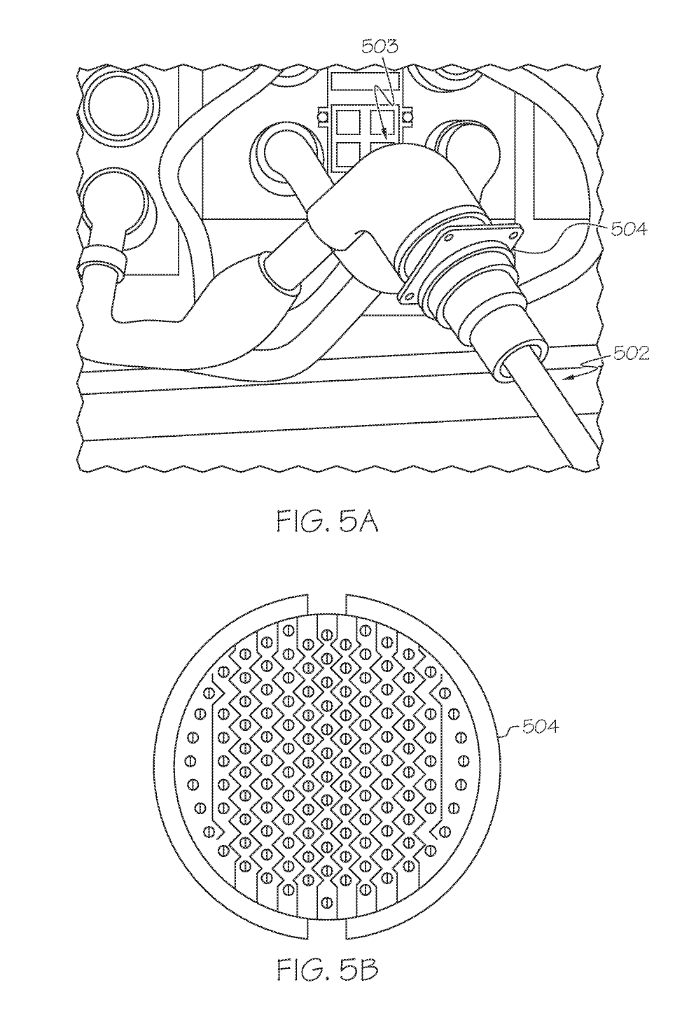

Data acquisition subsystem 110 includes any suitable combination of hardware and software (e.g., software stored within storage 108 and executable by CPU 106) configured to acquire stress, strain, and/or force information from integrated health sensors (or simply “sensors”) 102 within aircraft 100 as well as force sensor 116 of actuation system 114. In this regard, data acquisition subsystem 110 might be coupled to sensors 102 through a pre-existing coupling or interconnect that is already provided within aircraft 100. With brief reference to FIGS. 5A and 5B, for example, a cable 502 providing both physical and electrical connectivity may be connected to a pre-existing signal interconnect sensor fixture 503 as shown. In the illustrated embodiment, a connector with an array of electrical interconnect pins in a known arrangement (504) is employed. On an F-18 aircraft, for example, a 128-pin connector may be removed from the Signal Data Computer and connected to the calibration system. The connector includes all of the signal lines to the integrated health sensors aboard the aircraft (also referred to as a “strain signal bundle.”)

Referring again to FIG. 2, motion control subsystem 112 includes any suitable combination of hardware and software (e.g., software stored within storage 108 and executable by CPU 106) configured to provide control of actuation system 114. For example, actuation system 114 might include any number of linear actuators, motors, servos, or the like. Motion control subsystem 112 is then adapted to control the movement of such components in any suitable manner (e.g., through closed-loop control schemes known in the art).

Calibration system 200 might include additional components which, in the interest of simplicity, have not been illustrated. For example, system 200 might include a fail-safe microcontroller or an interface to an “emergency stop” component. System 200 might also typically include a communication bus and/or a power distribution bus.

Calibration system 200 preferably includes a software environment configured to carry out the calibration methods described herein, e.g. via the use of interpreted and/or compiled software code used in connection with one or more math/science libraries, e.g., MATLAB, Numpy/SciPy, R, or the like. Thus, storage 108 may include computer-readable instructions adapted to cause CPU 106 to perform the various steps described herein.

In one embodiment, an initialization file is provided within storage 108 to define operating parameters, for example, operating parameters corresponding to each mechanical coupling point 104. Example operating parameters include actuator speed (e.g., the speed at which actuator 115 should move during testing), not-to-exceed load (e.g., the maximum force actuation system 114 should apply, as determined by sensor 116), target calibration loads (e.g., at sensor 116), and calibration load duration.

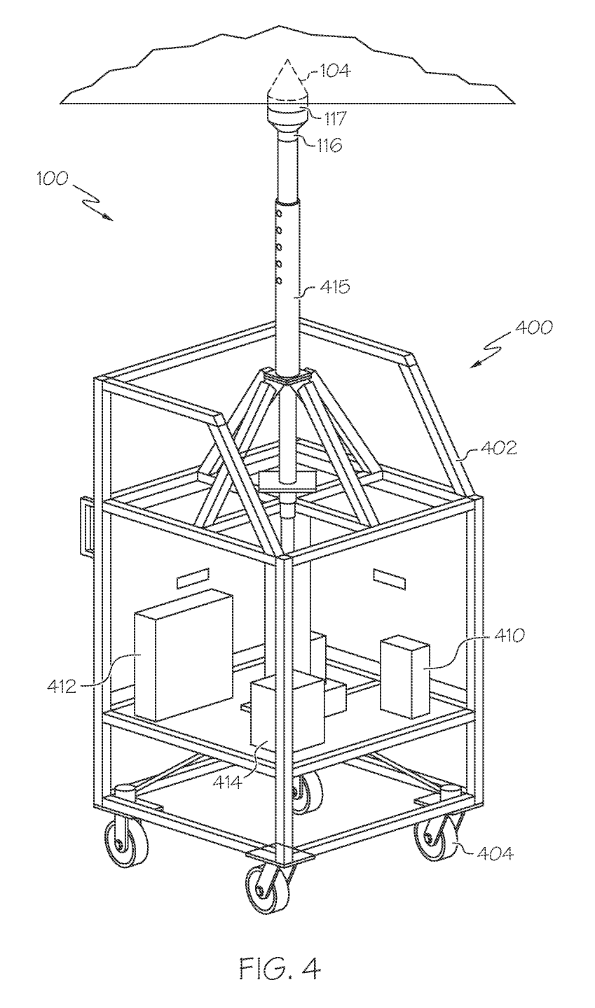

All or a portion of the components depicted in FIG. 2 may be integrated into a compact, portable device such that it can easily be relocated with respect to the aircraft under test. For example, FIG. 4 depicts an exemplary integrated, portable calibration system 400 in accordance with one embodiment of the invention (partially cut-away view). As shown, various subcomponents and/or subsystems are incorporated into a housing 402 that is relocatable by virtue of a set of lockable casters 404 coupled thereto (or other such components allowing lateral movement). In the illustrated embodiment, housing 402 includes a motor controller subsystem 410 (corresponding, e.g., to subsystem 112 of FIG. 2), a processor/memory submodule 412, data-acquisition subsystem 414 (corresponding, e.g., to subsystem 110 of FIG. 2), and linear actuator 415 (corresponding, e.g., to actuator 115 of FIG. 2). Processor/memory submodule 412 is configured, through appropriate hardware and/or software, to perform all or a portion of the functionality performed by system 200 of FIG. 2.

In an alternate embodiment, actuation system 114 of FIG. 2 includes one or more maintenance jacks of the type used during maintenance of aircraft. In such an embodiment, force sensor 116 is suitably integrated into the maintenance jack such that the applied force can be measured during testing.

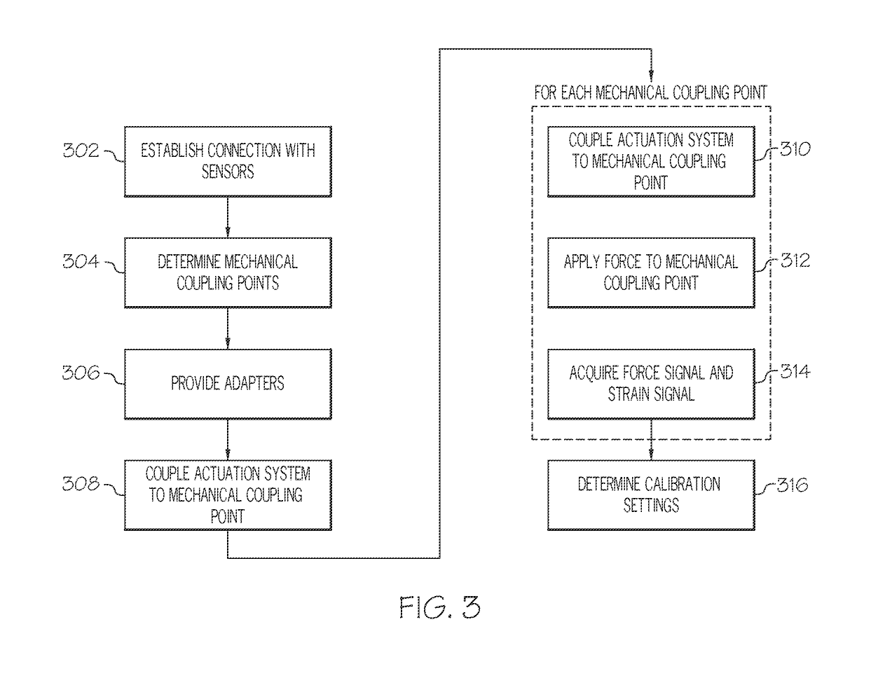

Having thus given an overview of a calibration system in accordance with various embodiments, FIG. 3 presents an exemplary method for calibrating an aircraft's structural health sensors. With reference to FIG. 3 in conjunction with the system of FIG. 2, the process begins with a connection being established with the plurality of structural health sensors 102 via a pre-existing interconnect fixture. This will typically involve first disconnecting the interconnect fixture within aircraft 100. Depending upon the nature of the pre-existing interconnect fixture, a variety of cables and interconnects may be used.

Next, in step 304, one or more of the plurality of mechanical coupling points 104 on aircraft 100 are selected or determined based on one or more structural characteristics of the aircraft and the location of each of the plurality of structural health sensors 102. These mechanical coupling points may be determined empirically, through computer simulation (e.g., CAD, finite element), or through any other suitable means. In general, the location of each mechanical coupling point is chosen to be relatively close to a corresponding sensor location while at the same time being amenable to mechanical coupling via a suitable adapter, as may be the case with various “hard points” on the aircraft—i.e., any location on the aircraft that is not likely to incur damage due to a localized load applied during the calibration procedure. This can be seen, conceptually, in FIG. 1. The plurality of adapters 117 are provided prior to calibration (step 306), wherein each adapter 117 is configured to mechanically interface with a respective mechanical coupling point 104, as described in further detail below.

During the calibration process, for each of the selected mechanical coupling points, the system is configured to couple an actuation system to the mechanical coupling point via an associated one of the adapters (step 310), then apply a force to the mechanical coupling point (step 312). In one embodiment, the force is applied to the mechanical coupling points quasi-statically—that is, very slowly (e.g., about 0.1-0.5 mm/s). In a particular embodiment, the force is applied upward and substantially normal to a platform on which the aircraft rests (e.g., via a hydraulic jack subsystem or electromechanical actuator integrated into actuation system 114).

While applying a force in order to exercise the structural health sensors 102, the system acquires a force signal indicative of the force applied to the mechanical coupling point 104 and at least one structural health signal indicative of the output of one or more of the plurality of structural health sensors 102. In this way, the sensitivity of the structural health sensors to an external load may be determined. Optionally, a deflection signal indicative of the deflection experienced by the mechanical coupling point 104 may also be acquired. Further, the various signals may be filtered or otherwise conditioned as is known in the art.

Finally, calibration settings (e.g., calibration factors, sensitivity ratios, and/or offsets) are determined for the plurality of structural health sensors based on the force signals, the deflection signals, and the structural health signals associated with each of the plurality of mechanical coupling points (step 316). The sensitivity factors may be compared to analytically determined sensitivity factors (e.g., obtained from a finite-element analysis) or to experimentally determined sensitivity factors (e.g., obtained from testing in a full-scale rig). The ratio of these factors provides a set of calibration settings. The calibration settings are therefore a measure of variation with respect to the reference sensitivity of that sensor location and a given load application method. Sensitivity factors may be expressed, for example, as microstrain (strain×10⁶) per pound of applied force (με/lbf). Calibration ratios may be then be expressed as a unitless value that scales (or “corrects”) the data determined during aircraft operation.

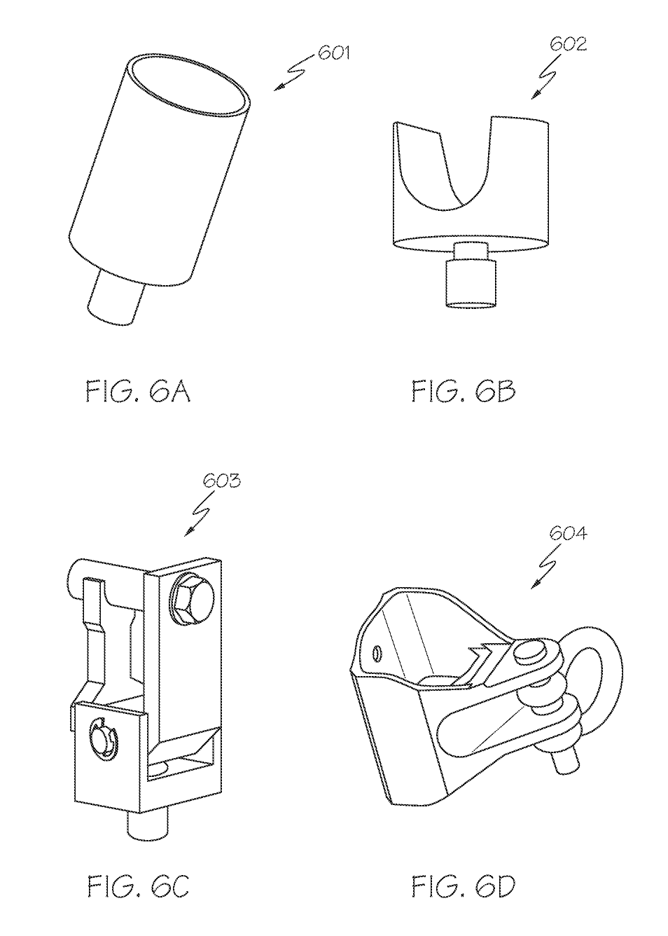

Depending upon the nature of the aircraft 100 under test, the number and type of mechanical adapters used during a particular testing session may vary greatly. A number of example mechanical adapters are illustrated in FIGS. 6A-6C for a particular aircraft design, i.e., an outer wing tip adapter 603, an inner wing jack point adapter 601, a horizontal stabilator spindle load adapter 602, and a vertical stabilizer load adapter 604.

In general, adapter 601 is configured to be removeably attached to the inner wing of an aircraft (i.e., at a jack point beneath the inner wing), adapter 602 is configured to be removeably attached to a horizontal stabilator (or “tail”) of an aircraft (e.g., at the spindle, a known structure), adapter 603 is configured to be removeably attached to an aircraft's outer wing tip (e.g., the underside of the wing tip), and adapter 604 is configured to be removeably attached to a vertical stabilizer.

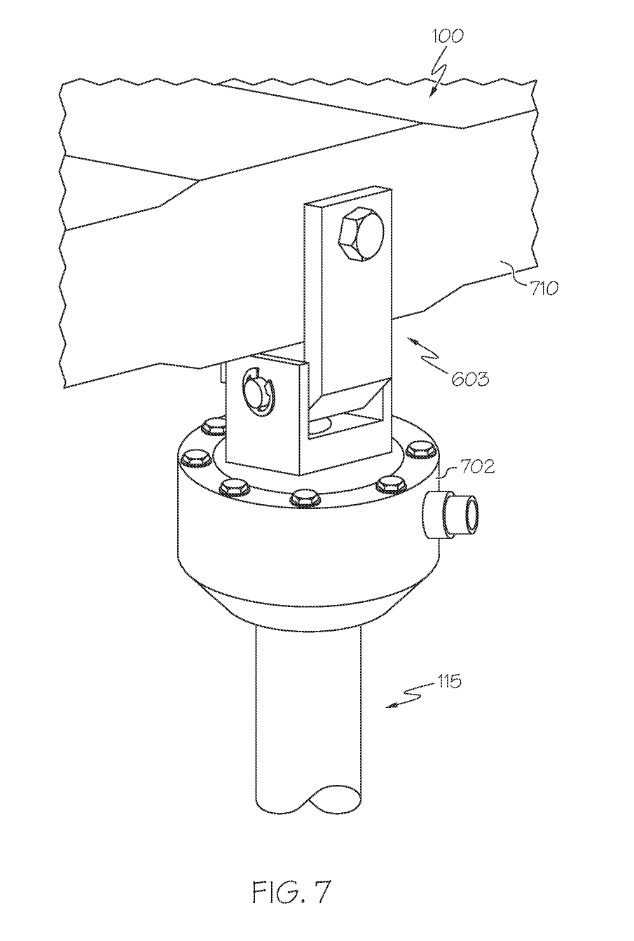

FIG. 7 illustrates an outer wing tip adapter 603 in accordance with one embodiment of the present invention. As shown, adapter 603 is removeably secured to a load cell 702 provided at one end of actuator 115. This may be referred to as a “double clevis” adapter. Adapter 603 then removeably engages an outer wing region 710 of aircraft 100 as shown.

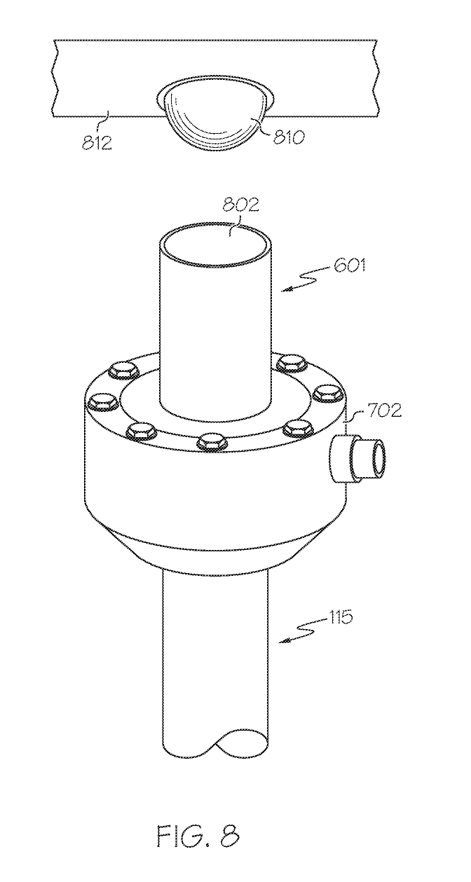

FIG. 8 illustrates an inner wing jack point adapter 601 in accordance with one embodiment of the present invention. Adapter 601 is removeably secured to load cell 702 of actuator 115. A concave (e.g., generally hemispherical) portion 802 of adapter 601 can then be used to engage the corresponding jack point 810 (which is typically also hemispherical) provided in an inner wing region 812.

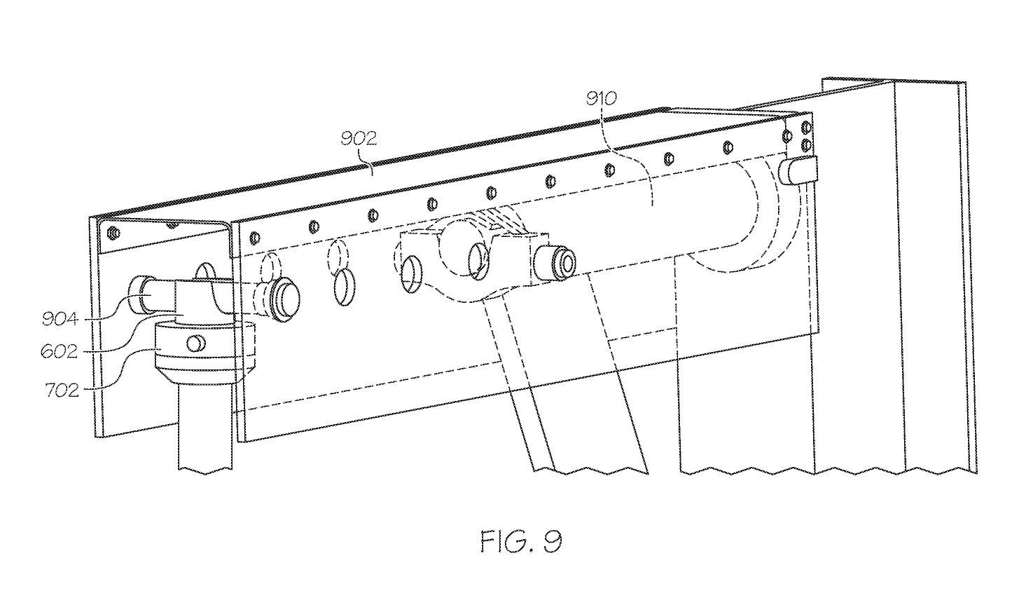

FIG. 9 illustrates a horizontal stabilator spindle load adapter 602 in accordance with one embodiment of the present invention. Adapter 602 is removeably secured to load cell 702 of actuator 115. A notch-shaped region of adapter 602 (as can be seen in FIG. 6B) engages a lateral component 904 of a “dummy” structure 902, which itself is removeably coupled to the conventional horizontal stabilator spindle 910. Thus, structure 902 effectively acts as the horizontal stabilator structure (which has been removed) during testing, rather than coupling to the stabilizer itself.

In one embodiment, force is applied laterally and substantially parallel to the platform on which the aircraft rests by means of a self-reacting load between paired structures, (such as vertical tails), or by means of an external reaction structure corresponding to actuation system 114. In one embodiment, for example, the vertical stabilizers are calibrated by pulling them towards each other with a turnbuckle and threaded rod, wherein a load cell is installed in series with this assembly. The assembly is attached to the flap hinges after the control surfaces are removed. An electromechanical actuator may also be employed to draw the stabilizers together. Such a system is attached to the flap hinges of the control surface (without removing the control surfaces) of the stabilizer with a claw-like or other such subassembly. In general, this embodiment might employ any suitable wire, chain, rod, or the like, along with a system adapted to either pull the stabilizers together or to/from an external reaction structure (while affording a means to measure the applied force).

In summary, the systems and methods described above provide a way to determine calibration factors (e.g. sensitivities) used to account for differences in the sensor installation and aircraft build so that engineers may accurately derive in-flight loads from measured in-flight strain data (i.e., errors of less than 2% in the derived loads) for individual strain gages on fleet aircraft. These in-flight loads are used in fatigue calculations, and so the increase in accuracy significantly improves remaining life predictions, improves safety, and reduces maintenance costs and aircraft downtime.

In one embodiment, the system is provided as a portable hardware package, with integrated software, that is used to capture aircraft-to-aircraft variations in installed strain sensors, allowing accurate prediction of remaining structural life for individual fleet aircraft. The calibration factor obtained during system operation is then used by fatigue life prediction engineers in conjunction with in-flight strain readings to accurately predict remaining life and schedule maintenance for each aircraft. Through the use of an automated calibration process, the illustrated system can be used by personnel with relatively little training, easing logistical burdens for performing strain sensor calibration. Further minimizing the calibration process logistics footprint, the technology is insensitive to variations in aircraft configuration parameters such as fuel weight, tire pressure, and store configuration. The system can be customized to different aircraft or strain sensor configurations as needed. Due to portability and low cost, the technology can be owned and operated on the fleet or squadron level, providing flexibility as to when and where calibration procedures can be performed.

The embodiments and examples set forth herein were presented in order to best explain the present invention and its particular application and to thereby enable those skilled in the art to make and use the invention. However, those skilled in the art will recognize that the foregoing description and examples have been presented for the purposes of illustration and example only. The description as set forth is not intended to be exhaustive or to limit the invention to the precise form disclosed.

1. A method of calibrating a plurality of structural health sensors incorporated into an aircraft, the plurality of structural health sensors coupled to a pre-existing signal interconnect fixture within the aircraft, the method comprising:
establishing a connection with the plurality of structural health sensors via the pre-existing interconnect fixture;
determining a plurality of mechanical coupling points on the aircraft based on one or more structural characteristics of the aircraft and the location of each of the plurality of structural health sensors;
providing a plurality of adapters, each configured to mechanically interface with a respective mechanical coupling point;
for each of the mechanical coupling points:
coupling an actuation system to the mechanical coupling point via an associated one of the adapters; and
applying a force to the mechanical coupling point with the actuation system while acquiring a force signal indicative of the force applied to the mechanical coupling point and at least one structural health signal indicative of the output of one or more of the plurality of structural health sensors; and
determining calibration settings for the plurality of structural health sensors based on the force signals and the structural health signals associated with each of the plurality of mechanical coupling points.

2. The method of claim 1, wherein the force is applied to mechanical coupling points quasi-statically.

3. The method of claim 1, wherein the force is applied upward and substantially normal to a platform on which the aircraft rests.

4. The method of claim 1, wherein the force is applied laterally and substantially parallel to a platform on which the aircraft rests via a self-reacting load between paired structures of the aircraft.

5. The method of claim 1, wherein providing a plurality of adapters includes providing at least one of an inner wing jack point adapter, a horizontal stabilator spindle load adapter, an outer wing-tip load adapter, and a vertical stabilizer load adapter.

6. The method of claim 1, wherein at least one of the mechanical coupling points corresponds to a hard point on the aircraft.

7. A calibration system configured to determine calibration settings for a plurality of structural health sensors incorporated into an aircraft, the calibration system comprising:
a plurality of adapters, each configured to mechanically interface with a respective mechanical coupling point on the aircraft;
an actuation system configured to accept each of the plurality of adapters, the actuation system configured to apply a force to each of the respective mechanical coupling points;
a data acquisition subsystem configured to acquire a force signal indicative of the force applied to the mechanical coupling point and at least one structural health signal indicative of the output of one or more of the plurality of structural health sensors; and
a processor coupled to the data acquisition subsystem, the processor configured to determine calibration settings for the plurality of structural health sensors based on the force signals and the structural health signals associated with each of the plurality of mechanical coupling points.

8. The calibration system of claim 7, wherein the actuation system is configured to apply the force to the mechanical coupling points quasi-statically.

9. The calibration system of claim 7, wherein the actuation system is configured to apply the force upward and substantially normal to a platform on which the aircraft rests.

10. The calibration system of claim 7, wherein the actuation system is configured to apply the force laterally and substantially parallel to a platform on which the aircraft rests via a self-reacting load between paired structures of the aircraft.

11. The calibration system of claim 7, wherein the plurality of adapters includes providing at least one of an inner wing jack point adapter, an outer wing-tip load adapter, a horizontal stabilator spindle load adapter, and a vertical stabilizer load adapter.

12. The calibration system of claim 7, wherein at least one of the mechanical coupling points corresponds to a hard point on the aircraft.

13. The calibration system of claim 7, wherein data acquisition system is configured to establishing a connection with the plurality of structural health sensors via a pre-existing interconnect fixture within the aircraft.

14. The calibration system of claim 7, further including a relocatable housing configured to contain at least the data acquisition system and the processor.

15. The calibration system of claim 7, wherein the actuation system includes one or more maintenance jacks configured to apply the force.

16. The calibration system of claim 7, wherein the processor is configured to determine the calibration settings based in part on a deflection signal associated with the actuation system.

17. The calibration system of claim 7, wherein the actuation system includes a load cell adapted to be mechanically coupled to each of the plurality of adapters.

18. A computer program product including non-transitory computer-readable instructions adapted to cause a processor to perform the steps of:
instructing an actuation system to apply a force to a mechanical coupling point on an aircraft;
instructing a data acquisition subsystem to acquire a force signal indicative of the force applied to the mechanical coupling point, and a structural health signal indicative of an output of a structural health sensor in the aircraft; and
determining calibration settings for the structural health sensors based on the force signal and the structural health signal associated.

19. The computer program product of claim 18, wherein the instructions cause the processor to instruct the actuation system to apply the force to the mechanical coupling points quasi-statically.

20. The computer program product of claim 18, wherein the instructions cause the processor to further determine the calibration settings based on a deflection signal associated with the actuation system.
